(19) United States
(12) Patent Application Publication
(10) Pub. No.: US 2007/0148353 A1
(43) Pub. Date: Jun. 28, 2007

(54) Ink for screen printing, method for producing same, and method for manufacturing edge and damper of speaker using same

(76) Inventors: Shinya Mizone, Mie (JP); Yoshiyuki Takahashi, Mie (JP); Yukio Sone, Osaka (JP); Keiji Okuda, Nara (JP)

Correspondence Address: WENDEROTH, LIND & PONACK L.L.P., 2033 K. STREET, NW, SUITE 800, WASHINGTON, DC, 20006, US

(21) Appl. No.: 10/589,287

(22) PCT Filed: Apr. 8, 2005
(86) PCT No.: PCT/JP05/07275

§ 371 Date: Aug. 11, 2006

(30) Foreign Application Priority Data
Apr. 9, 2004 (JP) 2004-115063

(51) Int. Cl. B05D 5/00

(52) U.S. Cl. 427/256; 264/160; 106/31.1

(57) ABSTRACT

A screen printing ink includes micelle structural particles formed by aggregating molecules of ammonium acrylate to dispersed particles containing phenol resin, and a dispersion medium for dispersing the micelle structural particle.

### TECHNICAL FIELD

The present invention relates to an ink used for screen printing which is also called silk printing, a production method thereof, and a production method of an edge and a damper of a loud speaker using the ink.

### BACKGROUND ART

As is generally known, the screen printing is a type of method of obtaining a printed surface of a desired pattern. In the screen printing, a woven fabric called silk gauze or a screen which is equivalent to the silk gauze and has fine pores formed on an allover surface thereof is attached to a frame to be used as a plate. Stencil for defining a deposition range of an ink is overlapped on the plate to be brought into contact with the printed surface of a printing object such as a sheet of paper or fabric. Then, the ink is applied from a reverse side of the printed surface by a squeegee and then deposited on the printed surface via the pores.

This printing method has the following characteristics. 1) It is possible to print on an object of a fragile material since the plate surface which is elastic is pressed against the printing surface by a squeegee blade at a low printing pressure, 2) it is possible to print on a curved surface of a machinery and a rough surface such as that of a fabric, a foamed article, and a timber since the plate surface is flexible, 3) it is possible to achieve a three-dimensional appearance of the printed surface by using an ink in which coarse particles are mixed therein, and 4) it is possible to obtain a printed pattern of remarkable high accuracy by increasing fineness of a mesh of the pores of the plate by adjusting the mesh through selection of the silk gauze. Also, it is possible to set a thickness of a printing layer over a wide range and accurately by setting a thickness of the plate. Since the screen printing has various characteristics described above that cannot be achieved by other printing methods, the screen printing is applied widely to a commercial art printing field such as commercial advertisements, groceries, and clothing products, an industrial parts processing field, and so the like.

This printing method is applied also to manufacture of a vibration system component of a loud speaker as disclosed in Japanese Patent Unexamined Publication No. 2001-197590. That is, in the case of molding a diaphragm edge made of a fabric, a shape imparting material such as a phenol resin and a melamine resin is applied by the printing method in place of employing the conventional resin impregnation. Since a state of a printed film obtained by the screen printing, which is evaluated by an ink coating amount, a coating range, a coating thickness, and the like, is accurate and has good reproducibility, the screen printing is effective for improving performance and quality of the edge.

In order to achieve the state of the printed film which is accurate and of good reproducibility in the screen printing, selection of an ink viscosity and a change in time of the viscosity, i.e. settings for thixotropy, are important. Particularly, they are important for the above-mentioned speaker component parts such as a diaphragm edge and a damper or for the case of printing on fabrics, such as pattern printing, stamp printing, and the like on a clothing fabric.

In the case where the viscosity is high in the printing, the ink may not be supplied sufficiently from the pores of the plate when applying the ink by the squeegee. In such a case, an outline of the formed pattern or deposition of the ink on the printed surface can be unsatisfactory. When the ink has a low viscosity, the coating amount can be excessive. Particularly, in the case of printing on a fabric, the ink permeates the fabric to a reverse side of the fabric to cause a non-uniform printed film thickness, a defect appearance on the printed surface, and the like. Therefore, it is desirable that the ink viscosity is set accurately and is not influenced by ambient conditions during the printing.

In the case of a lack of thixotropy or poor thixotropy, storage stability is deteriorated since latex is solidified when long time has passed after production of ink. Also, since it is necessary to perform kneading again when the latex is solidified, the productivity is deteriorated. Further, fluidity of the ink remains as it is after completion of printing, so that the ink permeates the fabric to the reverse side to result in a product defect. As described above, an advanced technology is required for easily setting the important physical property parameters, including a fundamental viscosity, of the ink appropriate for the printing process during production of the ink.

### DISCLOSURE OF THE INVENTION

A screen printing ink of the present invention has a micelle structural particle formed by aggregating molecules of ammonium acrylate to dispersed particles containing a phenol resin, and a dispersion medium for dispersing the micelle structural particle. Since a viscosity of this ink changes along with changes in size and shape of the micelle structural particle, it is possible to set the viscosity to a desired value depending on a mesh and a thickness of a plate by changing an amount of a water-soluble viscosity improver. Therefore, the ink having such constitution is applicable to various usages. This ink is usable for screen printing in the case of producing speaker edges and dampers. Also, this ink is prepared by preparing latex in which the dispersed particles containing the phenol resin are dispersed into the dispersion medium, and mixing the viscosity improver containing the ammonium acrylate to the latex.

### BRIEF DESCRIPTION OF THE DRAWINGS

FIG. 1A is a diagram for explaining a structure of latex used for preparing a screen printing ink according to an exemplary embodiment of the present invention.

FIG. 1B is a diagram for explaining a structure of a water-soluble viscosity improver for preparing the screen printing ink according to the exemplary embodiment of the present invention.

FIG. 2 is a sectional view for explaining a micelle structure in the screen printing ink according to the exemplary embodiment of the present invention.

FIG. 3 is a diagram for explaining another micelle structure in the screen printing ink according to the exemplary embodiment of the present invention.

FIG. 4 is a partial sectional view showing a loud speaker for which the screen printing ink according to the exemplary embodiment of the present invention is used.

FIG. 5 is a perspective view showing an edge of the loud speaker shown in FIG. 4.

FIG. 6 is a diagram showing a procedure step of printing on the speaker edge shown in FIG. 5.

FIG. 7 is a perspective view showing a printed pattern on a fabric when manufacturing the speaker edge shown in FIG. 5.

FIG. 8 is a perspective view showing a damper of the loud speaker shown in FIG. 4.

FIG. 9 is a diagram showing a procedure of printing a pattern on a Japanese clothing fabric according to the exemplary embodiment of the present invention.

### DETAILED DESCRIPTION OF THE INVENTION

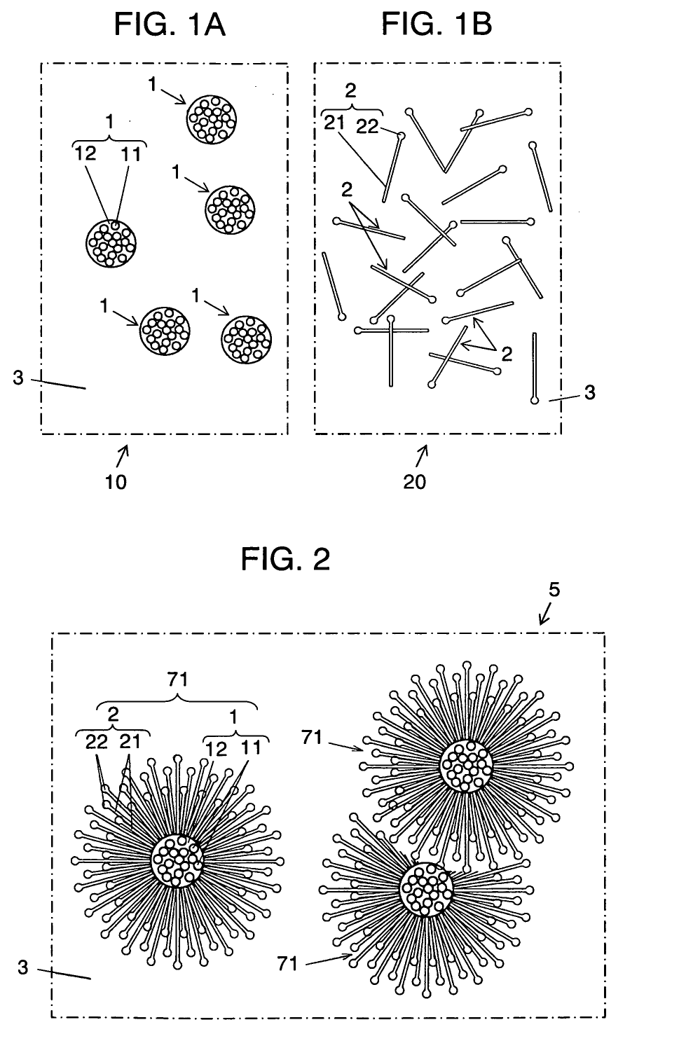

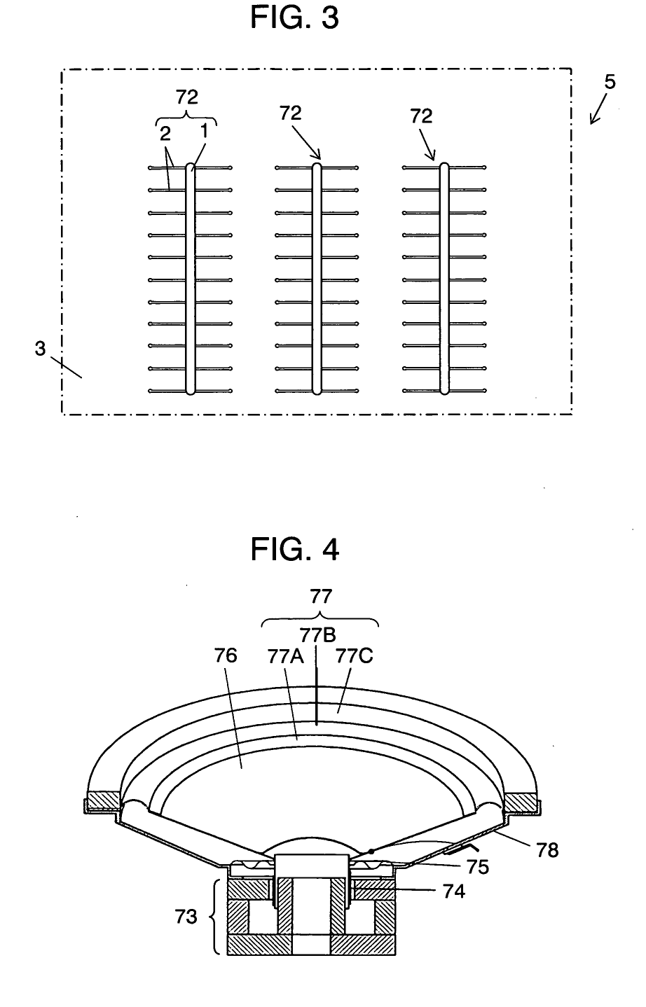

FIGS. 1A and 1B are diagrams for explaining structures of latex and a water-soluble viscosity improver to be used for preparing the screen printing ink according to an exemplary embodiment of the present invention. FIGS. 2 and 3 are sectional views for explaining micelle structures of the ink.

Screen printing ink (hereinafter referred to as “ink”) 5 according to this embodiment is prepared by mixing water-based latex 10 mainly containing a phenol resin and acryl resin-based water-soluble viscosity improver 20. In latex 10, fine particles 11 of the phenol resin are dispersed into water which is dispersion medium 3 as dispersed particles 1 covered with polyvinyl alcohol 12 as shown in FIG. 1A. Latex 10 is prepared by preparing a phenol resin solution by mixing fine particles 11 of the phenol resin and polyvinyl alcohol 12 and forming dispersed particles 1 by dispersing the solution into dispersion medium 3.

An aqueous solution of an ammonium acrylate, which serves as viscosity improver 20, is mixed with latex 10. Molecule 2 of ammonium acrylate contained in viscosity improver 20 has lipophilic acrylate group 21 and hydrophilic ammonium group 22 as shown in FIG. 1B.

A mixing ratio of ammonium acrylate is decided depending on a required viscosity of the ink. For example, in the case of using the ink for an edge and a damper of a loud speaker, a suitable mixing ratio in ink 5 is as follows: the phenol resin (solid content) is in a range from 1.0 wt % to 14.0 wt % and the ammonium acrylate is in a range from 2.0 wt % to 4.0 wt %. It is difficult to obtain a good printed surface when the mixing ratio is larger or smaller than the above range.

Viscosity improver 20 is preferably used in the range of neutrality. Specifically, it is preferable to set a hydrogen ion exponent to a range of from pH 6.5 to pH 8.5. A hydrogen ion exponent of prepared ink 5 may also be set to the range of from pH 6.5 to pH 8.5. When the hydrogen ion exponent deviates from the above range, the dispersed particles of the mixed latex are coagulated to be non-usable as an ink.

In ink 5 obtained as described above, molecules 2 of ammonium acrylate act in a similar manner as a surface active agent as shown in FIG. 2. That is, the portions of acrylate group 21 aggregate around dispersed particles 1 to be surrounded by the portions of hydrophilic ammonium group 22 in the form of clusters. Micelle structural particle (hereinafter referred to as “micelle”) 71 formed as described above is dispersed in water serving as dispersion medium 3. By forming micelle 71, apparent size and shape of the dispersed particles are changed to increase the viscosity in general, thereby developing thixotropy. In addition, since dispersion medium 3 is water, handling is easy.

Micelle 71 shown in FIG. 2 is generally called spherical micelle, and such a micelle appears when concentration thereof is near a critical micelle concentration. However, when an amount of the mixed ammonium acrylate is large, micelle structural particle (hereinafter referred as “micelle”) 72 in the form of layers is obtained as shown in FIG. 3. Since the viscosity changes with the changes in size and shape of the micelle structural particle, it is possible to set the viscosity of ink 5 to a desired value that is appropriate for a mesh and a thickness of a plate by changing the amount of ammonium acrylate.

Although it is described that each of micelles 71 and 72 includes the dispersed particles containing the phenol resin and the ammonium acrylate in this embodiment, materials for the micelles are not limited to the above. Synthetic resin latex of a different type and a polymer compound-based acid salt or a polymer compound-based surface active agent may be used. Examples of the synthetic resin latex include melamine resin, styrene-butadiene rubber, butadiene rubber, nitrile rubber, chloroprene rubber, isoprene rubber, ethylene-propylene-dien rubber, acrylic emulsion, polyurethane-based latex, and the like. Examples of the polymer compound-based acid salt include a salt having a sulfonate group. As the polymer compound-based surface active agent, a nonionic surface active agent is preferably used, and examples thereof include an ether type which is obtainable by an addition polymerization of a raw material having a hydroxide group such as a aliphatic acid ester, a higher alcohol and alkyl phenol, with ethylene oxide mainly; an ester/ether type obtained by adding ethylene oxide to an aliphatic acid or an ester of polyvalent alcohol and aliphatic acid; and the like.

Due to compatibility/incompatibility between the synthetic resin latex and the viscosity improver, it is necessary to select them appropriately. Among combinations of the synthetic resin latex and the viscosity improver, a combination of the phenol resin latex and the viscosity improver containing the ammonium acrylate is suitable for forming the micelle structural particle. Also, the phenol resin latex is excellent in shape imparting property.

Viscosity is increased when dispersed particles 1 form micelle 71 or 72, thereby developing the thixotropy. That is, the micelle structural particle has a specific thixotropy. Thanks to the thixotropy, it is possible to store ink 5 for a long period of time without coagulation otherwise caused by an increased viscosity during the storage after production. At the point of use of ink 5, it is possible to perform printing work at a predetermined viscosity after re-kneading without any further processing. When ink 5 adheres to a printed surface of a printing material after passing through pores of a screen, the viscosity of ink 5 starts to be increased again, so that the high viscosity state is achieved again at the time of entering a drying step after removing the plate. Therefore, in the case of printing on a porous printed surface such as a fabric, it is possible to prevent permeation to a reverse side of the printed surface and blur otherwise caused by ink running out of an outline of a printed pattern.

Hereinafter, specific examples of ink 5 described above will be given. A screen printing ink of sample A is a shape imparting agent for an edge or a damper serving as a vibration system component of a loud speaker. In sample A, a mixing ratio is set as follows: solid content of the phenol resin derived from latex 10 (resin content 43 wt %) is 13.2 wt % and content of ammonium acrylate derived from viscosity improver 20 is 2.5 wt %.

Viscosity improver 20 used in sample A is an aqueous solution of ammonium acrylate obtainable by destroying emulsion particles by adding ammonium water to a water-soluble acryl resin emulsion. Also, an ammonium acrylate aqueous solution may directly be used. Sample A is obtainable by mixing viscosity improver 20 with water-based latex 10 containing the phenol resin as the main ingredient. A hydrogen ion exponent of sample A is about pH 8, and a viscosity of sample A at the point of use is about 10 Pa·s. The viscosity is measured at 25° C. and 10 rpm except when specifically described.

A screen printing ink of sample B is used for printing a pattern on a Japanese clothing fabric by stamp printing. For preparation of sample B, a stock solution of an ink is obtained, in which a mixing ratio is as follows: solid content of the phenol resin derived from latex 10 (resin content: 43 wt %) is 13.2 wt % and content of ammonium acrylate derived from viscosity improver 20 is 2.5 wt % is obtained. A dye (or pigment) of an amount of 0.2 wt % is mixed with the stock solution. Thus-obtained sample B has a hydrogen ion exponent of about pH 7.5, and a viscosity at the point of use of sample B is about 6 Pass.

Hereinafter, various examples of using samples A and B for products and production of the products will be described in detail. At first, production of an edge for supporting a diaphragm of a loud speaker inside a frame with flexibility will be described.

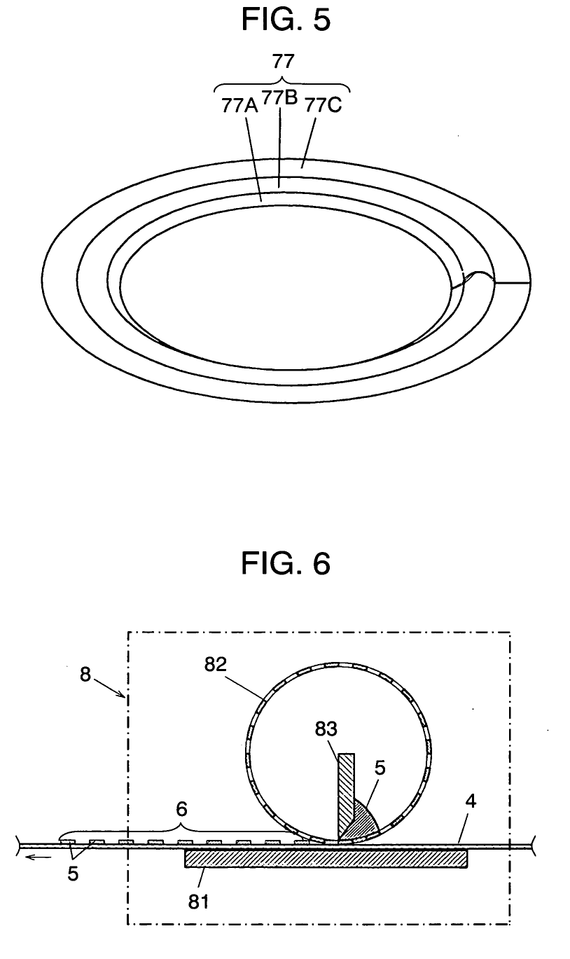

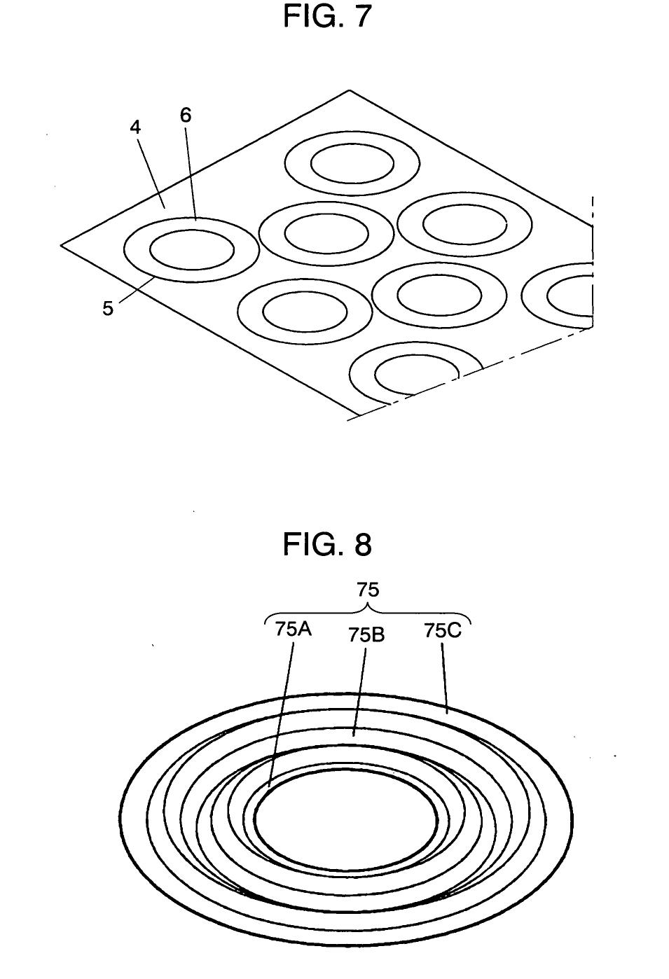

FIG. 4 is a partial vertical sectional view showing the loud speaker for which the screen printing ink according to the embodiment of the present invention is used. FIG. 5 is a perspective view showing the edge of the loud speaker shown in FIG. 4. FIG. 6 is a diagram showing a procedure step of printing the speaker edge shown in FIG. 5. FIG. 7 is a perspective view showing a printed pattern on a fabric in the case of producing the speaker edge shown in FIG. 5.

The loud speaker of FIG. 4 has magnetic circuit 73, voice coil 74, damper 75, diaphragm 76, edge 77, and frame 78. Voice coil 74 is disposed at a magnetic gap of magnetic circuit 73. A central portion of a tip of diaphragm 76 and frame 78 are connected to each other via voice coil 74 and damper 75, while an outer periphery of diaphragm 76 and an outer rim of frame 78 are connected to each other by edge 77.

Edge 77 as a single component has the shape of a ring as shown in FIG. 5, and inner attachment margin 77A, flexible portion 77B, and outer attachment margin 77C are coaxially formed. Edge 77 is manufactured as follows. To start with, printed pattern 6 of ink 5 is formed on a required portion of fabric 4 as shown in FIG. 7 by rotary screen printing machine (hereinafter referred to as “printing machine”) 8 of which a schematic structure is shown in FIG. 6. In this case, plural patterns in the form of a ring having the size that corresponds to flexible portion 77B after the processing are printed.

Printing machine 8 has endless belt 81, rotary screen mold 82, and flat plate squeegee 83. Ink 5 is filled into rotary screen mold 82 by flat plate squeegee 83. Printed pattern 6 is formed by printing the ink on fabric 4 placed on endless belt 81 from a side reverse to the ink filling side of rotary screen mold 82.

After that, the portion of printed pattern 6 is heat-molded into a predetermined shape. Then, a molded portion corresponding to edge 77 is cut out to obtain edge 77 shown in FIG. 5. The heat-molding and punching of the portion corresponding to edge 77 may be performed in one step.

Ink 5 used herein is sample A, for example. Therefore, a viscosity of ink 5 is easily set, and ink 5 has thixotropy and good storage stability as a coating composition. Since ink 5 is capable of maintaining an appropriate viscosity by simple re-kneading for printing, it has high printing productivity. Also, since ink 5 does not permeate the fabric to the reverse side thereof, the product defective fraction is low. Further, since the rotary screen printing method has the continuity, and since ink 5 achieves a uniform adhesion amount, edges 77 are manufactured with remarkably good productivity, uniform performance, and stable quality.

Hereinafter, production of damper 75 for supporting diaphragm 76 and voice coil 74 inside frame 78 with flexibility in the loud speaker shown in FIG. 4 in the same manner as edge 77 will be described.

As shown in FIG. 8, damper 75 has inner attachment margin 75A, outer attachment margin 75C, and flexible portion 75B provided between the both margins and formed of plural colgations. A production process of damper 75 is similar to that of edge 77. That is, ink 5 of sample A is used as a shape imparting material, and a printed pattern is formed on a required portion of a fabric by using printing machine 8. After that, the portion of the printed pattern is heat-molded into a predetermined shape, followed by cutting out the molded portion corresponding to damper 75. Damper 75 is obtained as described above. The heat-molding and punching of the portion corresponding to damper 75 may be performed in one step.

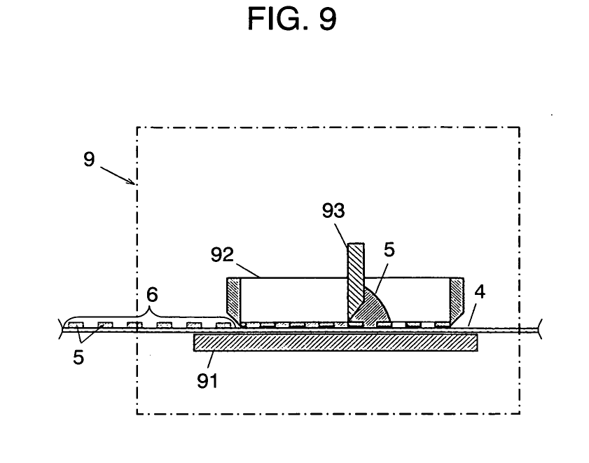

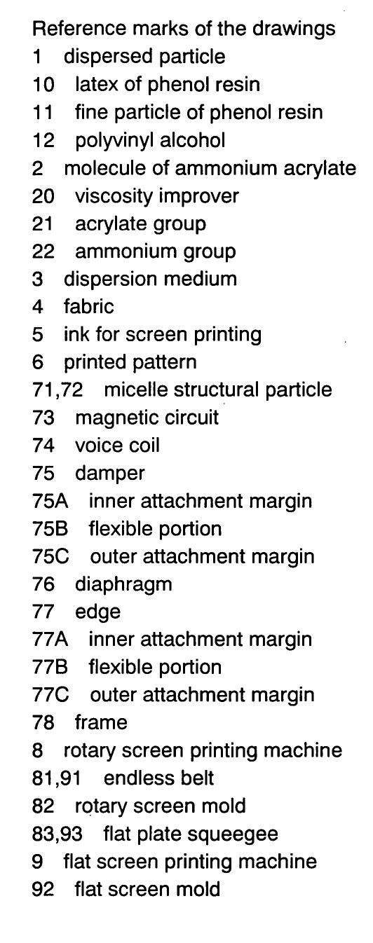

Hereinafter, a case of using sample B for printing (stamp printing) a pattern on a Japanese clothing fabric will be described. FIG. 9 is a schematic diagram showing a process of patterning on a Japanese clothing fabric according to the exemplary embodiment of the present invention.

Flat screen printing machine 9 has endless belt 91, flat screen mold 92, and flat plate squeegee 93. Ink 5 is filled into flat screen mold 92 by flat plate squeegee 93. Printed pattern 6 is formed by printing the ink on fabric 4 placed on endless belt 91 from a side reverse to the ink filling side of flat screen mold 92.

Plural types of inks corresponding to the number of colors assigned for the pattern are used by selecting types of pigments, and the printing is repeated for the number of times equal to the number of colors, thereby finishing the printing of the pattern on the Japanese clothing fabric.

Although this invention is described in conjunction with the embodiments in the foregoing, this invention is not limited to the constitutions of the foregoing embodiments. It is possible to practice this invention by properly modifying this invention insofar as the modifications have the constituent features of this invention, achieve objects of this invention, and are in the scope having the foregoing effects.

### INDUSTRIAL APPLICABILITY

It is possible to exhibit the characteristics of the screen printing method by using the screen printing ink of this invention. That is, an accurate ink transition amount is achieved, and reproducibility of lines on a printed surface and fitting of a plate surface to a surface shape of a printing material are improved. Also, adjustments of printing accuracy and hardness of the printed surface are facilitated. By making use of the excellent characteristics, it is possible to obtain high quality and high reliability printed materials. Particularly, in the case where the screen printing ink is used for an edge and a damper of a loud speaker, it is possible to impart a stable flexibility to them.

1. A screen printing ink comprising:
micelle structural particles formed by aggregating molecules of ammonium acrylate to dispersed particles containing phenol resin, and
a dispersion medium for dispersing the micelle structural particles.

2. The screen printing ink according to claim 1,
wherein the dispersion medium is water.

3. The screen printing ink according to claim 1,
wherein a hydrogen ion exponent of the ink is in a range of from pH 6.5 to pH 8.5.

4. The screen printing ink according to claim 1,
wherein the phenol resin is contained in an amount of from 1.0 wt % to 14.0 wt %, and the ammonium acrylate is contained in an amount of from 2.0 wt % to 4.0 wt %.

5. A screen printing ink production method comprising:
a step A for preparing latex by dispersing dispersed particles containing phenol resin into a dispersion medium, and
a step B for mixing a viscosity improver containing ammonium acrylate with the latex.

6. The screen printing ink production method according to claim 5, wherein
the step A includes;
preparing a phenol resin solution by mixing fine particles of the phenol resin and polyvinyl alcohol, and
preparing the dispersed particles by dispersing the phenol resin solution into the dispersion medium.

7. The screen printing ink production method according to claim 5,
wherein the viscosity improver is an aqueous solution of the ammonium acrylate.

8. The screen printing ink production method according to claim 5,
wherein the viscosity improver has a hydrogen ion exponent in a range of from pH 6.5 to pH 8.5.

9. A production method of a speaker edge comprising:
forming a printed pattern on a fabric by screen printing by using an ink, the ink including micelle structural particles formed by aggregating molecules of ammonium acrylate to dispersed particles containing phenol resin, and a dispersion medium for dispersing the micelle structural particles,
heat-molding a portion of the printed pattern into a predetermined shape, and
cutting out the heat-molding portion.

10. A production method of a speaker damper comprising:
forming a printed pattern on a fabric by screen printing by using an ink, the ink including micelle structural particles formed by aggregating molecules of ammonium acrylate to dispersed particles containing phenol resin, and a dispersion medium for dispersing the micelle structural particles,
heat-molding a portion of the printed pattern into a predetermined shape, and
cutting out the heat-molding portion.
